(19) United States
(12) Patent Application Publication
(10) Pub. No.: US 2006/0288740 A1
(43) Pub. Date: Dec. 28, 2006

(54) Heat-resistant optical fiber, a method of manufacturing the same, a method of fixing an optical fiber, and a heat-resistant optical fiber using a protective tube

(75) Inventors: Tomio Kaise, Nagano (JP); Asuka Nakayama, Nagano (JP); Hidehiko Shimizu, Nagano (JP); Tatuo Yamaguchi, Nagano (JP); Masanori Nonomura, Nagano (JP); Yasushi Murakami, Nagano (JP)

Correspondence Address: JORDAN AND HAMBURG LLP, 122 EAST 42ND STREET, SUITE 4000, NEW YORK, NY, 10168, US

(73) Assignee: TOTOKU ELECTRIC CO., LTD., Shinjuku-ku (JP)

(21) Appl. No.: 11/490,292

(22) Filed: Jul. 20, 2006

Related U.S. Application Data
(62) Division of application No. 11/352,516, filed on Feb. 9, 2006.

(30) Foreign Application Priority Data
Jun. 27, 2005 (JP) 2005-186123
Aug. 19, 2005 (JP) 2005-238055

(51) Int. Cl. C03B 37/016; C03C 25/10

(52) U.S. Cl. 65/395; 65/430

(57) ABSTRACT

To the outer peripheral surface of an optical fiber made of quartz or glass and having a core and a cladding is applied a microporous silica solution, which is synthesized from a mixture of silicon alcoxide, active alcohol for facilitating hydrolytic action, alcohol, and water, by means of the sol-gel process, followed by baking to form a thin film of microporous silica made chiefly of silicon. Microporous of the thin film of microporous silica have function of cushioning to cushion and restrain that micro cracks much existing in the cladding undergo growth when the optical fiber is bent so that the optical fiber is likely to be broken. And the thin film of microporous silica which made chiefly of silicon has high heat-resistant properties similarly to the optical fiber itself. Accordingly, a heat-resistant optical fiber very excellent in heat-resistant properties is provided.

This is a Divisional of Ser. No. 11/352,516 filed Feb. 9, 2006 which is now pending.

### PRIOR ART

Known to public hitherto is a heat-resistant optical fiber made of a conventional optical fiber comprising a core and a cladding and forming on the outer peripheral surface a polyimide resin coating further forming on its outer periphery a metallic coating (see, for example, Japanese Unexamined Utility Model Application No. HEI6-82608(1994)).

There is also known to public a heat-resistant optical fiber provided with a polyimide resin coating is formed on the outer peripheral surface of an optical fiber by means of the dipping method or the electroless plating method (see, for example, Japanese Patent No. 2567951).

Moreover, fixing the optical fiber is performed by use of plastic resin or ceramic resin having a smaller linear expansion coefficient (see, for example, Japanese Unexamined Patent Application No. 2004-125846).

It is also known to public a so-called “grating fiber” comprising an optical fiber having a photo sensitive core and provided on the outer peripheral surface with a covering made of ultraviolet-curing resin, silicon resin or carbon, and also provided at a part of the core with a grating part by applying light from sidewise of the covered optical fiber (see, for example, Japanese Unexamined Patent Application No. HEI 10-82919 (1998)).

Furthermore, there is known to public a technology using an optical fiber fit into a stainless capillary in order to provide an intrusion detection line which an intruder breaks to thereby cause the intrusion to be detected (see, for example, Japanese unexamined patent application 2000-306167).

And there is also known to public a technology using an optical fiber fit into a stainless capillary in order to provide a strain detection line for monitoring strain of bedrock or structures (see, for example, Japanese Unexamined Patent Application No. HEI 10-197297(1998)).

### SUMMARY OF THE INVENTION

The foregoing conventional heat-resistant optical fiber improves by use of the polyimide resin coating the “bending strength” of the optical fiber comprising the core and the cladding and improves heat-resistant properties by forming a metallic coating or a carbon coating on the outer peripheral surface of the polyimide resin coating.

However, a further higher heat-resistant properties is required, for example, in such application as measuring vibration, temperatures, or the like with a number of optical fiber coils set on bedrock near magma of volcanoes.

The technological method of forming the metallic coating on the outer peripheral surface of optical fiber using the Dipping Method has a problem of deterioration of properties of optical fiber from stress caused when melted metal set hard. And that forming the metallic coating on the optical fiber's outer peripheral surface using the electroless plating method has a problem of low productivity due to that the film forming speed is very much slow.

Besides, the foregoing conventional grating fiber has such problem that when a strong light is applied sidewise of the covered fiber, the covering made of any of the materials such as ultraviolet-curing resin, silicon resin or carbon burns and wastes from the burning happen to stick onto the surface of optical fiber.

In case that the wastes from the burning stick onto the optical fiber surface, there causes such problem of making unstable controlling of reflective index and also that of damaging stability of the grating part.

In view of the above problems, the light may be applied after the covering is first removed so that damaging stability of the grating part by the wastes from burning is prevented. But, there causes another problem of increase of the number of manufacturing processes.

Furthermore, the foregoing conventional optical fiber fit into stainless capillary has a problem of insufficient heat-resistant properties of optical fiber (particularly, the covering).

Under the above circumstances, an object of the present invention is to provide a heat-resistant optical fiber very much excellent in heat-resistant efficiency, a method of manufacturing the same, and a heat-resistant optical fiber fit into a protective tubing, and further to provide a heat-resistant optical fiber which is able to be manufactured without necessity of increase of the number of manufacturing processes and is excellent in stability of the grating part.

On a basis of a first standpoint, the present invention provides a heat-resistant optical fiber comprising an optical fiber having a core and a cladding and provided on the outer peripheral surface of the optical fiber with a thin film of microporous silica made chiefly of silicon, the microporous silica porous having many micro apertures.

In the heat-resistant optical fiber according to the first standpoint, the micro apertures of the thin film of microporous silica have cushioning action, so that it is cushioned and prevented that when the optical fiber is bent, the micro cracks much existing in the cladding grow and the optical fiber becomes likely to be broken. Hence, the bending strength of the optical fiber is improved. And since the thin film of microporous silica having many micro apertures is made mainly of silicon, it has high heat-resistant effect as of the optical fiber itself, thereby providing a heat-resistant optical fiber having quite excellent heat-resistant properties.

Accordingly, the heat-resistant optical fiber according to the present invention is usable as an optical fiber coil for detecting vibration, etc under circumstances of high temperatures such as bedrocks near magma of a volcano.

On a second standpoint, the present invention provides a heat-resistant optical fiber structured as above wherein the thin film of microporous silica having many micro apertures is in thickness of 1 μm or less.

The thin film of microporous silica when made thicker tends to generate cracks inside when the thicker thin film of microporous silica is bent. Hence, in the heat-resistant optical fiber provided on the basis of the second standpoint, thickness of the thin film of microporous silica is set to be 1 μm or less. By this, thin film of microporous silica is prevented from generating cracks when thin film of microporous silica is bent.

The present invention does, on a third standpoint, provide a method of manufacturing a heat-resistant optical fiber involving applying on the outer peripheral surface of an optical fiber comprising a core and a cladding a microporous silica solution and baking the solution, thereby forming a thin film of microporous silica having many micro apertures made chiefly of silicon.

According to the method of manufacturing a heat-resistant optical fiber on the basis of the above third standpoint, the heat-resistant optical fiber based on the first standpoint could be manufactured continuously.

Upon a fourth standpoint, the present invention provides a method of manufacturing a heat-resistant optical fiber structured as above wherein the microporous silica solution is synthesized, with the sol-gel process, from a mixture of silicon alkoxide, active alcohol for facilitating hydrolyzing reaction, alcohol, and water.

According to the method of manufacturing a heat-resistant optical fiber based on the fourth standpoint, the microporous silica solution is synthesized with the sol-gel process, whereby lowering the cost to manufacture.

On a fifth standpoint, the present invention provides a heat-resistant optical fiber characterized in having a metallic coating formed on the outer peripheral surface of the thin film of microporous silica having many micro apertures in the heat-resistant optical fiber as set forth in claim 1 or 2.

In the heat-resistant optical fiber based on the fifth standpoint, the metallic coating protects the optical fiber and the thin film of microporous silica from the ambient air and an external force. Hence, the heat-resistant optical fiber is quite excellent in heat-resistant efficiency.

On a sixth standpoint, the present invention provides a method of manufacturing a heat-resistant optical fiber characterized in that after formation of the thin film of microporous silica having many micro apertures in the method of manufacturing a heat-resistant optical fiber as set forth in claim 3, a metallic coating is formed on the outer peripheral surface of the thin film of microporous silica by applying and baking an organic metal liquid or an organic metal paste.

The method of manufacturing a heat-resistant optical fiber based on the sixth standpoint in which the metallic coating is formed by applying and baking the organic metal liquid or an organic metal paste has not the fear or problem of deterioration of properties of the optical fiber as arising in the case using the Dipping method. Besides, the present manufacturing method shows notably higher productivity in comparison with the case using the electroless plating and is able to manufacture the heat-resistant optical fiber based on the fifth standpoint continuously and at high productivity.

On a seventh standpoint, the present invention provides a method of manufacturing a heat-resistant optical fiber characterized in that the organic metal liquid or organic metal paste in the method of manufacturing a heat-resistant optical fiber based on the sixth standpoint may be any of liquid gold, precious metal compositions for over-glaze in the state of liquid or paste, gold resinate paste, silver metallo-organic paste, or organic compositions paste containing palladium.

According to the method of manufacturing a heat-resistant optical fiber based on the seventh standpoint, a metallic thin film made particularly of gold, silver, platinum, or palladium among precious metal having higher reflectance is formed so that leakage of light from the optical fiber is prevented and loss of transmission of light can be particularly lessened.

On an eighth standpoint, the present invention provides a heat-resistant optical fiber characterized in that a protective covering is formed and provided on the outer peripheral surface of the thin film of microporous silica in the heat-resistant optical fiber based on the foregoing first or second standpoint.

In the heat-resistant optical fiber based on the eighth standpoint the protective covering protects the optical fiber and the thin film of microporous silica against ambient air or a foreign force, whereby enabling the heat-resistant optical fiber to be dealt with or handled easily.

On a ninth standpoint, the present invention provides a heat-resistant optical fiber characterized in that a grating part is formed and provided at a part of the core in the heat-resistant optical fiber based on the foregoing first, second, fifth, or eighth standpoint.

In the heat-resistant optical fiber based on the ninth standpoint, the heat-resistant optical fiber based on the first or second standpoint has high heat-resistant efficiency. Thus, even when a strong light is applied during the process of forming the grating part, the thin film of microporous silica does not burn, thereby not generating wastes from burning. Resultantly, that controlling of refractive index becomes unstable is eliminated, thereby providing a heat-resistant optical fiber excellent in stability of the grating part.

On the tenth standpoint, the present invention provides a method of fixing an optical fiber characterized in that a microporous silica solution made chiefly of silicon is applied and sticks to both of a heat-resistant optical fiber based on the first, second, fifth, eighth, or ninth standpoint and a fixture part and dried so that the heat-resistant optical fiber is fixed to the fixture part.

According to the method of fixing an optical fiber based on the tenth standpoint, the microporous silica solution is dried to form the microporous silica, thereby fixing the optical fiber to the fixture part. The microporous silica shows high heat-resistant properties since the principal constituent is silicon dioxide.

On an eleventh standpoint, the present invention provides a method of fixing an optical fiber characterized in that the fixture part in the method of fixing an optical fiber based on the tenth standpoint is a part of ceramic material.

According to the method of fixing an optical fiber based on the eleventh standpoint, the fixture part is a part of ceramic material, such as alumina, ceramics, concrete, or rock, so that it has high heat-resistant properties.

On a twelfth standpoint, the present invention provides a heat-resistant optical fiber fit into a protective tube characterized in that there are provided a heat-resistant optical fiber based on the first, second, fifth, eighth, or ninth standpoint, and a protective tube into which the heat-resistant optical fiber is inserted.

According to the heat-resistant optical fiber fit into the protective tube based on the twelfth standpoint, since the microporous silica film's principal constituent is silicon, it has very high heat-resistant properties. But, the thin film of microporous silica is poor in tensile strength or the like to thereby be hard to be dealt with, for example, the optical fiber would be broken upon laying operation. The optical fiber when inserted into the protective tube is given supplementary strength by the protective tube, whereby enabling the optical fiber to be easily dealt with without breakage upon the laying operation.

The heat-resistant optical fiber fit into the protective tube is usable for a communication fiber for WDM system.

### BRIEF DESCRIPTION OF THE DRAWINGS

FIG. 1 is a sectional view showing a heat-resistant optical fiber according to Embodiment 1.

FIG. 2 is an explanatory view showing the manufacturing process of the heat-resistant optical fiber according to Embodiment 1.

FIG. 3 is a flowchart showing the synthesizing process of the microporous silica solution with the sol-gel process.

FIG. 4 is a sectional view showing a heat-resistant optical fiber according to Embodiment 2.

FIG. 5 is an explanatory view showing the manufacturing process of the heat-resistant optical fiber according to Embodiment 2.

FIG. 6 is a sectional view showing a heat-resistant optical fiber according to Embodiment 3.

FIG. 7 is an explanatory view showing the manufacturing process of the heat-resistant optical fiber according to Embodiment 3.

FIG. 8 is a side view showing a heat-resistant optical fiber according to Embodiment 4.

FIG. 9 is a conception explanatory view showing a forming process of a grating part with “Phase-Mask” Method.

FIG. 10 is a side view showing a heat-resistant optical fiber according to Embodiment 5.

FIG. 11 is a side view showing a heat-resistant optical fiber according to Embodiment 6.

FIG. 12 is a perspective view showing a method of fixing an optical fiber according to Embodiment 7.

FIG. 13 is a front view and a side view showing a heat-resistant optical fiber fit into a protective tube according to Embodiment 8.

FIG. 14 is an explanatory view showing a method of manufacturing a heat-resistant optical fiber fit into a protective tube according to Embodiment 8.

### PREFERRED EMBODIMENTS OF THE INVENTION

Next, the present invention will be further detailed with referring to specific embodiments shown in the drawings. The present invention should not be limited to the detailed explanation.

### Embodiment 1

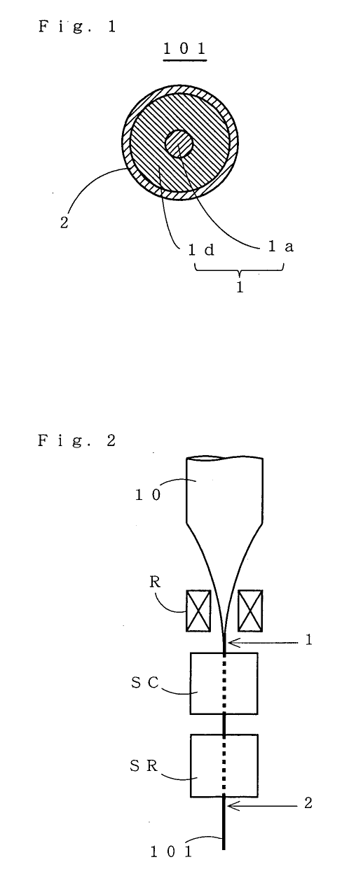

FIG. 1 is a sectional view showing a heat-resistant optical fiber 101 according to the embodiment 1.

The heat-resistant optical fiber 101 comprises or is structured with an optical fiber 1, which consists of a core 1a and a cladding 1d and is made of quartz or glass, and a thin film of microporous silica 2 made chiefly of silicon and formed on the outer peripheral surface of the optical fiber 1. The microporous silica has many micro apertures and forms the thin film of microporous silica 2.

Numerical exemplification is that the core 1a is in diameter of 10 μm and the cladding 1d in that of 125 μm.

The thin film of microporous silica 2 is in thickness of 20 nm(=0.02 μm) and has on the outer peripheral surface many micro apertures in diameter of 2 nm or less.

FIG. 2 is an explanatory view showing a manufacturing process of the heat-resistant optical fiber 101.

To the optical fiber 1 drawn out of a preform 10 through a heating furnace R, a microporous silica solution is applied by an applying unit SC for applying the microporous silica solution, followed by baking at a baking unit SR to form the thin film of microporous silica 2, thereby completing manufacturing of the heat-resistant optical fiber 101.

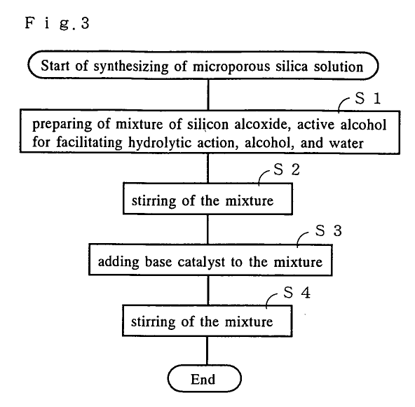

FIG. 3 is a flow chart of the synthesizing process of the microporous silica solution by use of the sol-gel process.

On the step S1, prepared is a mixture of silicon alcoxide, active alcohol for facilitating hydrolytic reaction, alcohol, and water.

Silicon alcoxide may use, for example, TMOS (tetramethoxysilane) or TEOS (tetraethylorthosilicate).

Active alcohol for facilitating hydrolytic reaction may use, for example, hydroxyacetone, 1-pentene-3-ol, or acetone cyanohydrin.

Alcohol may use, for example, methanol, ethanol, propanol, or butanol.

On the step S2, the mixture is stirred.

On the step S3, base catalyst is added into the mixture.

On the step S4, the mixture is stirred.

The microporous silica solution is synthesized according to the above steps.

The method of synthesizing the microporous silica solution has been published in the “Bulletin 2001 Autumn Meeting 34^{th} Chemical Engineering Association” and is also disclosed in Japanese Unexamined Patent Application No. 2004-292190.

According to the heat-resistant optical fiber 101 of the embodiment 1, growth of micro cracks much existing in the cladding 1d which is the cause of deterioration of strength of the optical fiber is restrained by the thin film of microporous silica 2, whereby preventing the deterioration of strength of the optical fiber. Moreover, the micro apertures of the thin film of microporous silica 2 have function of cushioning, thereby improving bending strength of the optical fiber 1. And the thin film of microporous silica 2 whose principal constituent is silicon has high heat-resistant properties, resulting in providing the heat-resistant optical fiber quite excellent in heat-resistant properties and strength.

### Embodiment 2

FIG. 4 is a sectional view showing a heat-resistant optical fiber 102 according to the embodiment 2.

The heat-resistant optical fiber 102 comprises or is structured with an optical fiber 1, which consists of a core 1a and a cladding 1d and is made of quartz or glass, a thin film of microporous silica 2 made chiefly of silicon and formed on the outer peripheral surface of the optical fiber 1, and a metallic coating 3 made of gold, silver, platinum, palladium, rhodium, chrome, bismuth, thorium, or, their alloy and formed on the outer peripheral surface of the thin film of microporous silica 2.

Numerical exemplification is that the core 1a is in diameter of 10 μm and the cladding 1d in that of 125 μm.

The thin film of microporous silica 2 is in thickness of approximately 500 nm(=0.5 μm) and has on the outer peripheral surface many micro apertures in diameter of 2 nm or less.

In case that the thin film of microporous silica 2 is set to be larger in thickness, the thin film of microporous silica 2 happens to have generation of cracks therein when the heat-resistant optical fiber is bent. Hence, it is preferable that thickness of the thin film of microporous silica 2 is set to 1 μm or less in order to prevent cracks from being generated in the thin film of microporous silica 2 when the heat-resistant optical fiber is bent.

The metallic coating 3 is in thickness of 20 μm or less. 50% or more of the composition of the metallic coating 3 is metallic component.

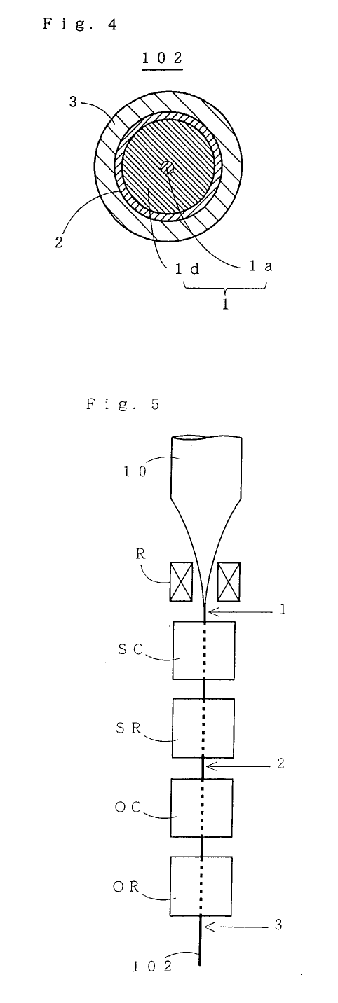

FIG. 5 is an explanatory view showing a manufacturing process of the heat-resistant optical fiber 102.

To the optical fiber 1 drawn out of a preform 10 through a heating furnace R, a microporous silica solution is applied by an applying unit SC for applying the microporous silica solution, followed by baking at a baking unit SR to form the thin film of microporous silica 2.

An organic metal liquid or an organic metal paste is applied onto the outer periphery of the thin film of microporous silica 2 by an applying unit OC for applying the organic metal, followed by baking at a baking unit OR to form the metallic coating 3, thereby completing manufacturing of the heat-resistant optical fiber 102.

The organic metal liquid or organic metal paste may be liquid gold, precious metal compositions for over-glaze in the state of liquid or paste, gold resinate paste, silver (Ag) metallo-organic paste, organic compositions paste containing palladium, or the like.

Liquid gold is commercially available, for example, liquid gold for over-glaze put on the market by Japan Liquid Gold Co. Ltd. (Kasugai City, Aichi Prefecture).

A precious metal composition for over-glaze in the state of liquid or paste has been disclosed, for example, in Japanese Examined Patent Application No. HEI 7-6067(1995).

Gold resinate paste has been disclosed, for example, in Japanese Patent No. 3203672.

Silver (Ag) metallo-organic paste has been disclosed, for example, in Japanese Unexamined Patent Application No. HEI 10-204297(1998).

Organic compositions paste containing palladium has been disclosed, for example, in Japanese Patent No. 3232057.

For a specific example, liquid gold HY-1991 (trade name) made by Japan Liquid Gold Co. Ltd. is applied by the organic metal applying unit OC, followed by drying at 150° C. for five minutes by the baking unit OR and also calcining at 600° C. for five minutes by the baking unit OR, thereby forming 0.1 μm thick gold alloy thin film 3 (gold is 90% or more, and rhodium, chrome, bismuth, thorium, etc are contained).

According to the manufacturing method shown in FIG. 5, there is no problem of deterioration of properties of optical fiber as that of the Dipping Method. And productivity can be notably improved in comparison with the electroless plating method.

According to the heat-resistant optical fiber 102 of the embodiment 2, the thin film of microporous silica 2 has micro apertures so that the metallic coating 3 is able to firmly stick to the thin film of microporous silica 2. The metallic coating 3 protects the optical fiber 1 and the thin film of microporous silica 2 against ambient air and an external force. Thus, a heat-resistant optical fiber very excellent in heat-resistant efficiency and strength is provided.

### Embodiment 3

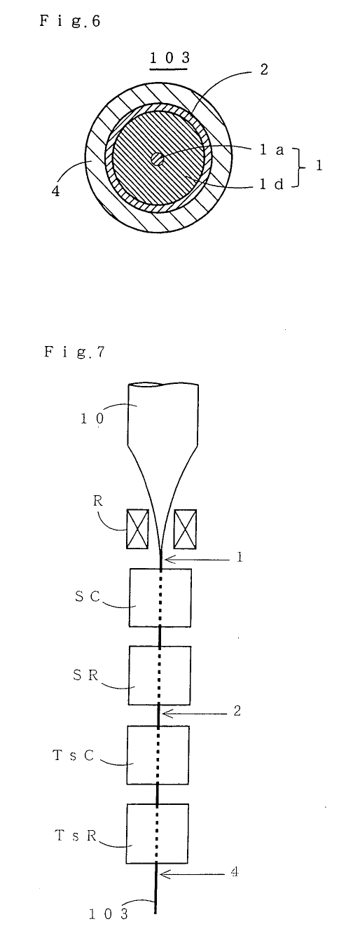

FIG. 6 is a sectional view showing a heat-resistant optical fiber 103 according to the embodiment 3.

The heat-resistant optical fiber 103 comprises or is structured with an optical fiber 1, which consists of a core 1a and a cladding 1d and is made of quartz or glass, a thin film of microporous silica 2 made chiefly of silicon dioxide and formed on the outer peripheral surface of the optical fiber 1, and a resin covering 4 formed on the outer peripheral surface of the thin film of microporous silica 2.

FIG. 7 is an explanatory view showing a manufacturing process of the heat-resistant optical fiber 103.

To the optical fiber 1 drawn out of a preform 10 through a heating furnace R, a microporous silica solution is applied by an applying unit SC for applying the microporous silica solution, followed by baking at a baking unit SR to form the thin film of microporous silica 2.

Next, to the outer peripheral part of the thin film of microporous silica 2, thermoset resin such as silicon, polyimide, epoxy, or urethane or the like is applied by an applying unit TsC for applying the thermoset resin, followed by baking at a baking unit TsR to form the resin covering 4, thereby completing manufacturing of the heat-resistant optical fiber 103.

According to the heat-resistant optical fiber 103 of the embodiment 3, handling or dealing with the heat-resistant optical fiber is made easy.

### Embodiment 4

FIG. 8 is a sectional view showing a heat-resistant optical fiber 104 according to the embodiment 4.

The heat-resistant optical fiber 104 comprises or is structured with an optical fiber 1, which consists of a core 1a and a cladding 1d and is made of quartz or glass, a thin film of microporous silica 2 made chiefly of silicon dioxide and formed on the outer peripheral surface of the optical fiber 1, and a grating part 1g formed at a part of the core 1a by applying light sidewise of the heat-resistant optical fiber 101 having the thin film of microporous silica 2.

Numerical exemplification is that the core 1a is in diameter of 10 μm and the cladding 1d in that of 125 μm.

The thin film of microporous silica 2 is in thickness of approximately. 500 nm(=0.5 μm) and has on the outer peripheral surface many micro apertures in diameter of 2 nm or less.

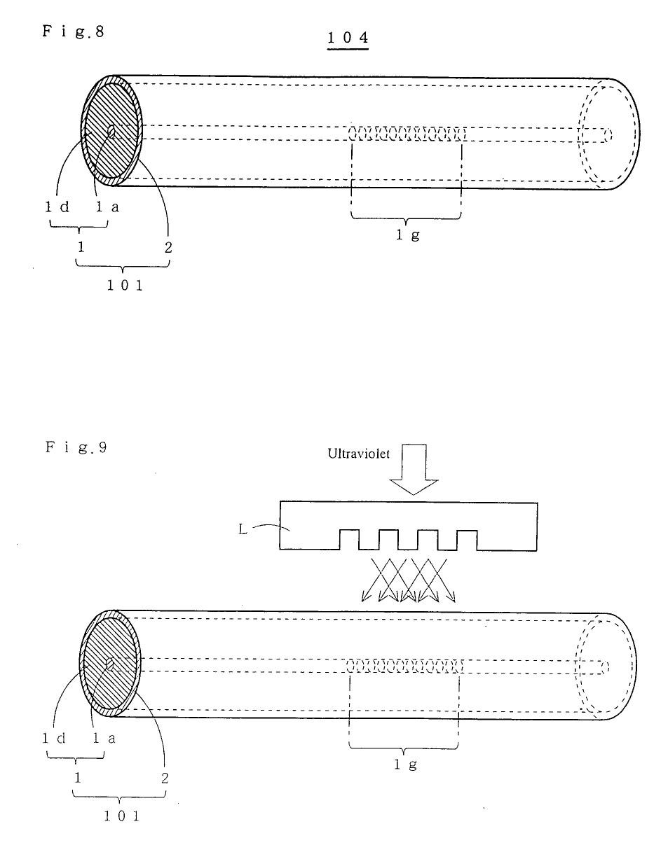

FIG. 9 is a concept explanatory view showing a forming process of the grating part 1g by means of the Phase-mask method.

Ultraviolet is applied through a phase-mask L sidewise of the heat-resistant optical fiber 101 to thereby form the grating part 1g at a part of the core 1a.

The grating part 1g may be formed otherwise by means of the Two Beam Interference Method.

According to the heat-resistant optical fiber 104 of the embodiment 4, the heat-resistant optical fiber 101 has high heat-resistant properties. Thus, in the forming process of the grating part 1g, when high light is applied, the covering, that is, the thin film of microporous silica 2 does not burn, whereby generating no wastes from burning. As a result, it is eliminated that control of refractive index is made unstable, thereby providing the heat-resistant optical fiber 104 showing excellent stability of the grating part 1g.

### Embodiment 5

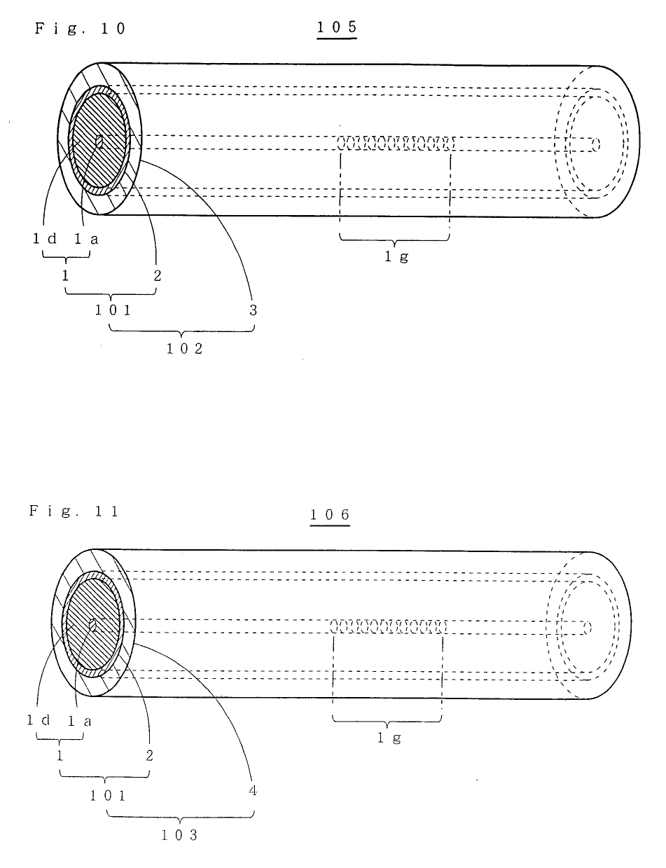

FIG. 10 is a sectional view showing a heat-resistant optical fiber 105 according to the embodiment 5.

The heat-resistant optical fiber 105 comprises or is structured with: a heat-resistant optical fiber 104, which is provided with an optical fiber 1 having a core 1a and a cladding 1d and made of quartz or glass, a thin film of microporous silica 2 made chiefly of silicon dioxide and formed on the outer peripheral surface of the optical fiber 1, and a grating part 1g formed at a part of the core 1a by applying light sidewise of the heat-resistant optical fiber 101 having the thin film of microporous silica 2; and a metallic coating 3 made of gold, silver, platinum, palladium, rhodium, chrome, bismuth, thorium, or the like, or their alloy and formed on the outer peripheral surface of the thin film of microporous silica 2 of the heat-resistant optical fiber 104.

The method of forming the metallic coating 3 does, similarly to the embodiment 2, involve to apply an organic metal liquid or an organic metal paste to the outer periphery of the thin film of microporous silica 2, followed by baking.

### Embodiment 6

FIG. 11 is a sectional view showing a heat-resistant optical fiber 106 according to the embodiment 6.

The heat-resistant optical fiber 106 comprises or is structured with: a heat-resistant optical fiber 103, which is provided with an optical fiber 1 having a core 1a and a cladding 1d and made of quartz or glass, a thin film of microporous silica 2 made chiefly of silicon dioxide and formed on the outer peripheral surface of the optical fiber 1, and a grating part 1g formed at a part of the core 1a by applying light sidewise of the heat-resistant optical fiber 101 having the thin film of microporous silica 2; and a resin covering 4 formed on the outer peripheral surface of the thin film of microporous silica 2 of the heat-resistant optical fiber 103.

The method of forming the resin covering 4 is similar to the embodiment 3.

### Embodiment 7

FIG. 12 is a perspective view showing a method of fixing an optical fiber according to the embodiment 7.

The heat-resistant optical fiber 101 through 106 of the embodiments 1 through 6 is placed on the fixture part 200 to be joined thereto. The microporous silica solution made chiefly of silicon is applied to adhere to both of the heat-resistant optical fiber 101 to 106 and the fixture part 200, followed by heating and drying to form a microporous silica 201, so that the optical fiber 101 to 106 is fixed onto the fixture part 200.

The fixture part 200 may be a part of ceramic material such as alumina, ceramics, concrete, rocks or the like.

Numerical exemplification is that outer diameter of the optical fiber 101 to 106 is about 166 cm. Thickness of the microporous silica 201 is about 200 μm.

According to the method of fixing the optical fiber of the embodiment 5, the microporous silica 201 which is made chiefly of silicon has very excellent heat-resistant properties.

### Embodiment 8

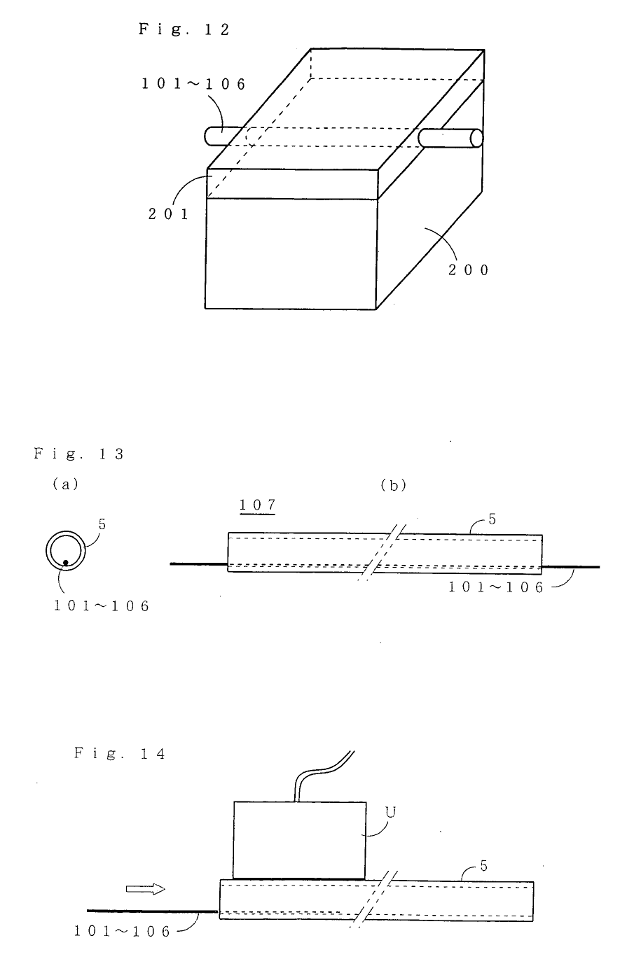

FIG. 13 is a front view and a side view showing a heat-resistant optical fiber 107 fit into a protective tube according to the embodiment 8.

The heat-resistant optical fiber 107 fit into the protective tube comprises a heat-resistant optical fiber 101 through 106 of the embodiments 1 to 6 and a protective tube 5 into which the heat-resistant optical fiber is inserted.

The protective tube 5 is a metallic conduit made of stainless steel, copper or the like.

As shown in FIG. 14, the heat resistant optical fiber 101 to 106 is inserted into the protective tube 5 with ultrasonic oscillator U being contacted with the protective tube 5 for applying thereto ultrasonic oscillation, whereby enabling work of inserting the optical fiber to be easily carried out.

In place of or in addition to applying ultrasonic oscillation to the protective tube 5, with ultrasonic oscillator U being contacted with the heat-resistant optical fiber 101 to 106 for applying thereto ultrasonic oscillation, the heat-resistant optical fiber 101 to 106 may be inserted into the protective tube 5.

According to the heat-resistant optical fiber 107 of the embodiment 8, the thin film of microporous silica 2 which is made chiefly of silicon has very excellent heat-resistant properties. Besides, the heat-resistant optical fiber 101 to 106 is inserted into the protective tube 5 so that strength is supplemented. Hence, the optical fiber is easily handled or dealt with as not broken upon laying operation. Furthermore, the heat-resistant optical fiber having the resin covering 4 formed on the outer peripheral surface provides easy work of inserting the heat-resistant optical fiber into the protective tube 5.

What we claimed is:

1. A method of manufacturing a heat-resistant optical fiber involving that a microporous silica solution is applied onto the outer peripheral surface of an optical fiber having a core and a cladding, followed by baking to form a thin film of microporous silica made chiefly of silicon.

2. A method of manufacturing a heat-resistant optical fiber as set forth in claim 1, wherein the microporous silica solution is synthesized from a mixture of silicon alcoxide, active alcohol for facilitating hydrolytic action, alcohol, and water by means of the sol-gel process.

3. A method of manufacturing a heat-resistant optical fiber as set forth in claim 1, wherein after forming the thin film of microporous silica, a metallic coating is formed on the outer peripheral surface of the thin film of microporous silica by applying and baking an organic metal liquid or an organic metal paste.

4. A method of manufacturing a heat-resistant optical fiber as set forth in claim 3, wherein the organic metal liquid or the organic metal paste is any of liquid gold, precious metal compositions for over-glaze in the state of liquid or paste, gold resinate paste, silver metallo-organic paste, and organic compositions paste containing palladium.
